(19) United States
(12) Patent Application Publication
(10) Pub. No.: US 2009/0288770 A1
(43) Pub. Date: Nov. 26, 2009

(54) SURFACE-PROMOTED CURE OF ONE-PART CATIONICALLY CURABLE COMPOSITIONS

(75) Inventors: David Farrell, Kingswood (IE); Ciaran B. McArdle, Dublin (IE); Michael Doherty, Donegal (IE); Emilie Barriau, Duesseldorf (DE); Rainer Schoenfeld, Duesseldorf (DE)

Correspondence Address: Loctite Corporation, One Henkel Way, Rocky Hill, CT, 06067, US

(73) Assignees: Loctite (R&D) Limited, Dublin (IE); Henkel AG & Co. KGaA, Duesseldorf (DE)

(21) Appl. No.: 12/470,779

(22) Filed: May 22, 2009

Related U.S. Application Data
(60) Provisional application No. 61/055,575, filed on May 23, 2008.

(51) Int. Cl. B32B 27/26; C08L 63/00

(52) U.S. Cl. 156/332; 525/418

(57) ABSTRACT

The present invention relates to cationically curable compositions for curing on a surface comprising a cationically curable component, and an initiator component capable of initiating cure of the cationically curable component. The initiator comprises at least one metal salt, which is chosen so that it is reduced at the surface, and where the standard reduction potential of the initiator component is greater than the standard reduction potential of the surface, and where when the composition is placed in contact with the surface, the metal salt of the initiator component of the composition is reduced at the surface, thereby initiating cure of the cationically curable component of the composition. No catalytic component is required in the composition for efficient cure.

### FIELD OF THE INVENTION

The present invention relates to stable one-part cationically curable compositions for curing on a surface.

### DISCUSSION OF BACKGROUND ART

### Reduction-Oxidation (RedOx) Cationic Polymerisation

RedOx cationic polymerizations involve oxidation and reduction processes [Holtzclaw, H. F.; Robinson, W. R.; Odom, J. D.; General Chemistry 1991, 9^{th} Ed., Heath (Pub.), p. 44]. When an atom, either free or in a molecule or ion, loses an electron or electrons, it is oxidised and its oxidation number increases. When an atom, either free or in a molecule or ion, gains an electron or electrons, it is reduced and its oxidation number decreases. Oxidation and reduction always occur simultaneously, as if one atom gains electrons then another atom must provide the electrons and be oxidised. In a RedOx couple, one species acts as a reducing agent, the other as an oxidizing agent. When a RedOx reaction occurs the reducing agent gives up or donates electrons to another reactant, which it causes to be reduced. Therefore the reducing agent is itself oxidised because it has lost electrons. The oxidising agent accepts or gains electrons and causes the reducing agent to be oxidised while it is itself reduced. A comparison of the relative oxidising or reducing strengths of strength of the two reagents in a redox couple permits determination of which one is the reducing agent and which one is the oxidising agent. The strength of reducing or oxidising agents can be determined from their standard reduction (E_{red}⁰) or oxidation (Eₒₓ⁰) potentials.

Onium salts have been widely used in cationically curable formulations. Extensive investigation into the use of onium salts as photoinitiators for cationic polymerisation led to the realisation that during the course of the photochemical reaction the onium cation undergoes photochemical reduction. In particular, diaryliodonium salts have been used in cationically curable formulations. Extensive investigation into the use of diaryliodonium salts (1) as photoinitiators for cationic polymerisation led to the realisation that during the course of the photochemical reaction iodine undergoes a reduction in oxidation state from +3 to +1.

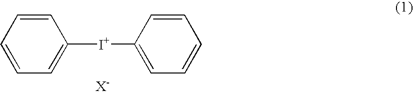

Crivello et al (J. V. Crivello and J. H. W. Lam, J. Polym. Sci., 1981, 19, 539-548) propose that the action of light on the diaryliodonium salt liberates radical intermediates, see Scheme 1. A resulting cascading series of reactions results in reduction of the oxidation state of iodine in the diaryliodonium salt. The aryliodine cation radicals generated during the photolysis process are extremely reactive species and react with solvents, monomers, or impurities (denoted SH in the scheme) to produce a protonic acid. The protonic acid in turn reacts with the cationically curable monomer resulting in polymerisation.

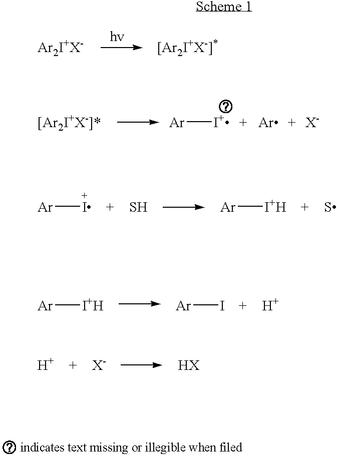

Diaryliodonium salts as initiators of cationic polymerisation via RedOx type chemistry have also been the subject of investigation. The general premise here was that, in the presence of a chemical reducing agent, the iodine component of the diaryliodonium salt could be reduced resulting in the generation of the protonic acid species HX, as shown in Scheme 2 (below), which will in turn initiate cationic polymerisation.

Ar₂I⁺X⁻+R—H→ArI+Ar⁺+R⁺+HX Scheme 2

Crivello and co-workers developed diaryliodonium salt/reducing agent couples incorporating ascorbic acid (J. V. Crivello and J. H. W. Lam, J. Polym. Sci., 1981, 19, 539-548), benzoin (J. V. Crivello and J. L. Lee, J. Polym. Sci., 1983, 21, 1097-1110), and tin (J. V. Crivello and J. L. Lee, Makromol. Chem., 1983, 184, 463-473). Direct reduction of the iodonium salt (an onium salt) by the reducing agent is inefficient. Consequently, there is the need to incorporate a copper catalyst in order to achieve efficient polymerization. Thus, such RedOx cationic initiation packages are effectively three component systems—the salt, the reducing agent and the catalyst.

These Crivello RedOx systems thus suffer from the drawback that direct reduction of the “onium” salt by the reducing agent is highly inefficient. Copper salts were required for efficient electron transfer. However, even in the absence of a catalyst very slow electron transfer between the reducing agent and the onium salt is observable rendering compositions having reducing agent and onium salt together in a composition inappropriate for long-term storage. There is thus still an unsatisfied need for suitable curable formulations which provide alternatives to the conventional onium formulations set out above.

### Lewis Acid Metallic Salts as Initiators for Cationic Polymerisation

Lewis acids in the form of metal salts have been used as initiators of cationic polymerization (Collomb, J. et al.; Eur. Poly. J., 1980, 16, 1135-1144; Collomb, J.; Gandini, A.; Cheradamme, H.; Macromol. Chem. Rapid Commun., 1980, 1, 489-491). Many strong Lewis acid initiators have been shown to function by the direct initiation of the monomer (Scheme 3) (Collomb, J.; Gandini, A.; Cheradamme, H.; Macromol. Chem. Rapid Commun., 1980, 1, 489-491). The stronger the Lewis acid the more pronounced is its initiating power.

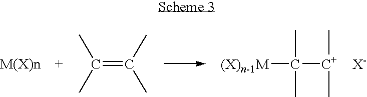

Not all Lewis acid metal salts react with cationically polymerizable monomers. Many can be formulated as the initiating component in storage stable one-component cationically polymerisable systems (Castell, P. et al.; Polymer, 2000, 41(24), 8465-8474). In these instances decomposition of the initiator and activation of polymerization is typically achieved by thermal or electromagnetic radiation curing processes (Castell, P. et al.; Polymer, 2000, 41(24), 8465-8474).

There is thus still an unsatisfied need for suitable curable formulations which provide alternatives to the conventional Lewis acid metal salt formulations set out above, which will cure in the absence of thermal or electromagnetic radiation curing processes.

### SUMMARY OF THE INVENTION

The invention provides a stable one-part cationically curable composition for curing on a surface comprising:
(i) a cationically curable component; and
(ii) an initiator component comprising at least one metal salt;

where the standard reduction potential of the initiator component is greater than the standard reduction potential of the surface, and

where when the composition is placed in contact with the surface, the metal salt of the initiator component of the composition is reduced at the surface, thereby initiating cure of the cationically curable component of the composition.

References to standard reduction potentials in this specification indicate the tendency of a species to acquire electrons and thereby be reduced. Standard reduction potentials are measured under standard conditions. 25° C., 1 M concentration, a pressure of 1 atm and elements in their pure state.

Desirably, the metal salt of the composition comprises a transition metal cation. Suitable metals include silver, copper and combinations thereof. The metal salt may be substituted with a ligand. The metal salt counterions may be chosen from the group consisting of ClO₄⁻, BF₄⁻, PF₆⁻, SbF₆⁻, AsF₆⁻, (C₆F₅)₄B anion, (C₆F₅)₄Ga anion, Carborane anion, triflimide (trifluoromethanesulfonate) anion, bis-triflimide anion, anions based thereon and combinations thereof. Further desirably, the metal salt counterions may be chosen from the group consisting of ClO₄⁻, BF₄⁻, PF₆⁻, SbF₆⁻ and combinations thereof.

The solubility of the metal salt may be modified by changing the counterion, the addition and/or substitution of ligands to the metal of the metal salt and combinations thereof. This will allow for efficient electron transfer between the surface and the metal salt to be observed as appropriate solubility is achieved.

The cationically curable component desirably has at least one functional group selected from the group consisting of epoxy, vinyl, oxetane, thioxetane, episulfide, tetrahydrofuran, oxazoline, oxazine, lactone, trioxane, dioxane, styrene with combinations thereof also being embraced by the present invention. Further desirably, the cationically curable component has at least one functional group selected from epoxy, episulfide, oxetane, thioxetane, and combinations thereof. Preferably, the cationically curable component has at least one functional group selected from epoxy, oxetane and combinations thereof.

Desirably, the surfaces to which the compositions of the present invention are applied may comprise a metal, metal oxide or metal alloy. Further desirably, the surface may comprise a metal or metal oxide. Preferably, the surface may comprise a metal. Suitable surfaces can be selected from iron, steel, mild steel, gritblasted mild steel, aluminium, aluminium oxide, copper, zinc, zinc oxide, zinc bichromate, and stainless steel. References to aluminium and aluminium oxide include alclad aluminium (low copper content), and oxide removed alclad aluminium (low copper content) respectively. Desirably, the surface can be selected from steel and aluminium. Metal salts suitable for use in compositions for curing on steel or aluminium surfaces may be chosen from silver salts, copper salts and combinations thereof, and where the counterions of the silver and copper salts may be chosen from ClO₄⁻, BF₄⁻, PF₆⁻, SbF₆⁻ and combinations thereof.

In general, the inventive compositions disclosed herein can cure on oxidised metal surfaces without the need for additional etchant or oxide remover. However, the compositions of the invention may optionally include an oxide remover. For example, including an etchant or oxide remover, such as those comprising chloride ions and/or a zinc (II) salt, in formulations of the invention allows etching of any oxide layer. This will in turn expose the (zero-oxidation state) metal below, which is then sufficiently active to allow reduction of the transition metal salt.

The RedOx cationic systems discussed herein do not require any additional reducing agent. They are stable until applied to a substrate which is capable of participating in a RedOx reaction, thus fulfilling the role of a conventional reducing agent component. The compositions of the present invention can thus be utilized in any application in which curing on a metal surface is required. The compositions of the invention are storage stable even as a one-part composition and require no special packaging unlike prior art compositions, which tend to be multi-component compositions.

The compositions of the present invention do not require an additional catalyst for efficient curing. The present invention utilizes appropriate selection of the initiator component relative to the surface on which the composition is to be applied and cured. Thus surface promoted RedOx chemistry can be utilized to initiate cure in cationically curable compositions. However, it will be appreciated that compositions according to the invention may optionally comprise a catalyst to affect electron transfer between the surface and the metal salt of the composition. This may be useful where even greater cure speeds are required. Suitable catalysts include transition metal salts.

The inventive compositions described herein will generally be useful as adhesives, sealants or coatings, and can be used in a wide range of industrial applications including metal bonding, thread-locking, flange sealing, and structural bonding amongst others.

The inventive compositions may be encapsulated if it is desired to do so. Suitable encapsulation techniques comprise, but are not limited to, coacervation, softgel and co-extrusion.

Alternatively, the inventive compositions may be used in a pre-applied format. It will be appreciated that the term pre-applied is to be construed as taking the material in an encapsulated form (typically but not necessarily micro-encapsulated) and dispersing said capsules in a liquid binder system that can be dried (e.g. thermal removal of water or an organic solvent, or by photo-curing the binder) on the desired substrate. A film of material remains which contains the curable composition (for example adhesive liquid for example in the form of filled capsules). The curable composition can be released for cure by physically rupturing the material (for example capsules) when the user wishes to activate the composition, e.g. in pre-applied threadlocking adhesives the coated screw threaded part is activated by screwing together with its reciprocally threaded part for example a threaded receiver or nut.

The invention further extends to a process for bonding two substrates together comprising the steps of:
(i) applying a composition comprising:
   i) a cationically curable component; and
   ii) an initiator component comprising at least one metal; to at least one substrate, and
(ii) mating the first and second substrates so as to form a bond with the composition,
   where the standard reduction potential of the initiator component is greater than the standard reduction potential of at least one of the substrates.

In one particular embodiment, both substrates comprise a metal. Where the second substrate comprises a different metal substrate to the first metal substrate the composition of the invention may comprise more than one type of metal salt. Thus, the invention also provides for curable compositions wherein the inclusion of more than one type of metal salt can be used to bond different metal substrates together.

Desirably, the metal of the metal salt of the inventive compositions of the present invention is lower in the reactivity series than the metal surface on which it is to be cured.

Metallic substrates can also be bonded to non-metallic substrates. For instance mild steel may be bonded to e-coated steel (e-coat is an organic paint which is electrodeposited, with an electrical current, to a metallic surface, such as steel).

Moreover, the inventive compositions of the present invention can be utilised to form (polymer) coatings on parts such as metallic parts.

The invention also relates to a pack comprising:

a) a container; and

b) a cationically curable composition according to the present invention, wherein the container may be air permeable. Alternatively, the container may not air permeable.

### BRIEF DESCRIPTION OF THE DRAWING

FIG. 1 is a plot of the Exotherm of Polymerisation of a two-part system comprising the RedOx couple ascorbyl-6-palmitate:diphenyliodonium hexafluorophosphate in an epoxy resin as a function of time (in days) at a temperature of 25° C.

### DETAILED DESCRIPTION OF THE INVENTION

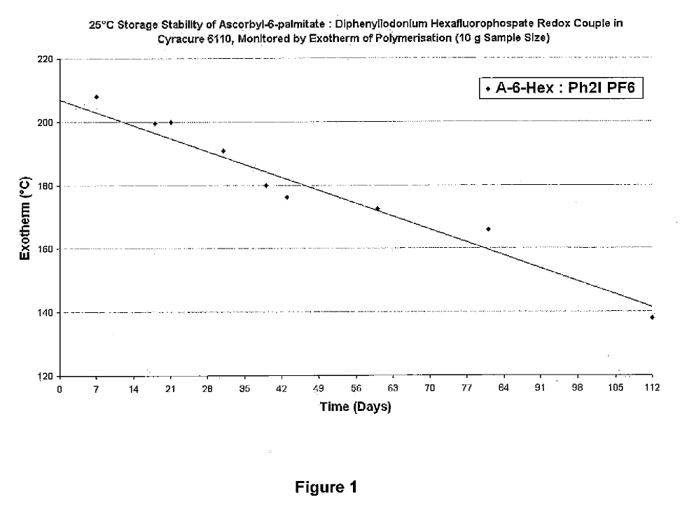

FIG. 1 is a graphical representation of the stability of a two-part system comprising the ascorbyl-6-palmitate:diphenyliodonium hexafluorophosphate redox couple in the epoxy resin Cyracure 6110. The stability of the composition was evaluated by measuring the Exotherm of Polymerisation of 10 g samples of the above two-part system stored over varying periods of time. The graph clearly shows an inverse relationship between heat liberated and the number of days the system was stored prior to use. After 112 days a significant reduction in the measured exotherm of polymerisation was observable indicating considerably reduced reactivity of the composition. Additionally, there was a significant increase in the formulation viscosity so the formulation was difficult to dispense and work with

The electrochemical series is a measure of the oxidising and reducing power of a substance based on its standard potential. The standard potential of a substance is measure relative to the hydrogen electrode. A metal with a negative standard potential has a thermodynamic tendency to reduce hydrogen ions in solution, whereas the ions of a metal with a positive standard potential have a tendency to be reduced by hydrogen gas. The reactivity series, shown in Scheme 4 (below), is an extension of the electrochemical series.

Scheme 4

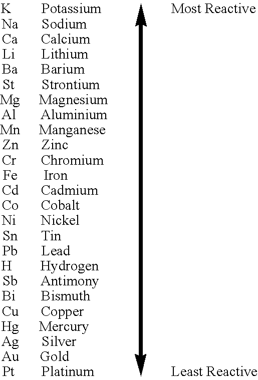

Ordinarily, only a metal or element positioned higher in the reactivity series can reduce another metal or element that is lower down in the reactivity series e.g. Iron can reduce Tin but not Potassium. It is appreciated that the order of the reactivity series can be (changed) inverted from that shown in Scheme 4. The terms “higher” and “lower” will be understood however as referring to a reactivity series having at the most reactive at the top and the least reactive at the bottom in the sequence shown in Scheme 4. In any event in the context of the present invention it will be appreciated that the metal of the metal salt is chosen so that it is reducible at the surface to which it is applied.

### EXAMPLES

It was found that by using a commercially available copper priming aerosol applied to a cycloaliphatic epoxy resin Cyracure 6110 containing an ascorbyl-6-hexadecanoate:diphenyliodonium hexafluorophosphate redox couple polymerized at room temperature to give usable cure strengths on a reasonable timescale (<24 hr). Of the known redox couples this was the least stable and not usable in a reliable two-component system. Polymerization did not occur without copper primer being applied to the substrate. Other redox couples based upon alternative onium-type salts were ineffective as surface curing adhesives even when the substrate was primed with copper. In Crivello, J. V.; Lee, J. L.; J. Polym. Sci. Part A: Polm. Chem., 1983, 21, 1097-1110, the suggestion was made that a two-part system based upon these redox cationic components may be possible. Our investigations have shown this to be unlikely as combinations of these three components in a two-part system is storage unstable on a practical timescale (see FIG. 1).

All preparations discussed below were carried out in the dark as these salts are known to be photosensitive. All formulations were mixed thoroughly for a period of 16 hr prior to use to ensure homogeneity.

### RedOx Cationic Systems

### General Procedure for Preparation of Formulations:

To monomer (10 g) was added a quantity of initiator salt. The salt was thoroughly dissolved in the monomer by continuous stirring (16 hours) at room temperature. All samples were kept covered to exclude light during preparation and while in storage.

### General Procedure for Testing Formulations:

A standard test method was followed for testing all adhesive formulations based on ASTM E177 and ASTM E6.

Apparatus

Tension testing machine, equipped with a suitable load cell.

Test Specimens

Lap-shear specimens, as specified in the quality specification, product or test program.

Assembly Procedure
1. Five test specimens were used for each test.
2. Specimen surface was prepared where necessary, i.e. mild steel lap-shears are grit blasted with silicon carbide.
3. Test specimens were cleaned by wiping with acetone or isopropanol before assembly.
4. Bond area on each lap-shear was 322.6 mm² or 0.5 in². This is marked before applying the adhesive sample.
5. A sufficient quantity of adhesive was applied to the prepared surface of one lap-shear.
6. A second lap-shear was placed onto the adhesive and the assembly was clamped on each side of the bond area.

Test Procedure

After allowing for cure as specified in test program the shear strength was determined as follows:
1. The test specimen was placed in the grips of the testing machine so that the outer 25.4 mm (1 in.) of each end were grasped be the jaws. The long axis of the test specimen coincided with the direction of applied tensile force through the centre line of the grip assembly.
2. The assembly was tested at a crosshead speed of 2.0 mm/min or 0.05 in./min., unless otherwise specified.
3. The load at failure was recorded.

The following information was recorded:
1. Identification of the adhesive including name or number, and lot number.
2. Identification of the test specimens used including substrate and dimensions.
3. Surface preparation used to prepare the test specimens.
4. Cure conditions (Typically ambient room temperature only, 20-25° C.).
5. Test Conditions (Standard Temperature and Pressure i.e. Room temperature).
6. Environmental conditioning, if any (None, all substrates to be bonded are freshly prepared before use).
7. Number of specimens tested, if other than 5 (Typically an average of 5 results for each quoted result).
8. Results for each specimen.
9. Average shear strength for all replicates.
10. Failure mode for each specimen when required by the quality specification, product profile, or test program.
11. Any deviation from this method.

### Example 1

(Diphenyliodonium)PF₆ (0.20 g, mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25° C. on:
Grit Blasted Mild Steel Lapshears: No Cure
Glass Lapshears: No Cure

### Example 2

[Ag(Cyclohexen)₂]SbF₆ (0.19 g, 0.47 mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25° C. on:
Grit Blasted Mild Steel Lapshears: 3.5 N/mm²

### Example 3

[Ag(Cyclododecene)₂]SbF6 (0.27 g, 0.47 mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25 ° C. on:
Grit Blasted Mild Steel Lapshears: 4 N/mm²

### Example 4

[Ag(Hexadien)n]SbF₆ (0.19 g, 0.47 mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25° C. on:
Grit Blasted Mild Steel Lapshears: 2.5 N/mm²

### Example 5

[Ag(1,9-Decadiene)n]SbF₆ (0.24 g, 0.47 mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25° C. on:
Grit Blasted Mild Steel Lapshears: 2.5 N/mm²

### Example 6

[Ag(1,7-octadiene)ₙ]SbF₆ (0.21 g, 0.47 mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25° C. on:
Grit Blasted Mild Steel Lapshears: 3.5 N/mm²

### Example 7

[Ag(15-Crown-5)]SbF₆ (0.32 g, 0.47 mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25° C. on:
Grit Blasted Mild Steel Lapshears: 5.5 N/mm²

### Example 8

[Ag(1,5-Cyclooctadien)₂]SbF₆ (0.24 g, 0.47 mmol) was dissolved in the cycloaliphatic diepoxide monomer Cyracure 6110, 3,4-epoxycyclohexylmethy-3,4-epoxycyclohexane carboxylate, (10 g).

Adhesive performance following 24 hr at 25° C. on:
Grit Blasted Mild Steel Lapshears: 5.5 N/mm²
Aluminum: 3.5 N/mm²
Aluminium (Alclad-Low Copper): 2.0 N/mm²
Aluminium (Scratched to remove oxide): 5.0 N/mm²
Stainless steel: 3.0 N/mm²

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A cationically curable composition for curing on a surface comprising:
(i) a cationically curable component; and
(ii) an initiator component comprising at least one metal salt;
wherein the standard reduction potential of the initiator component is greater than the standard reduction potential of the surface, and
wherein when the composition is placed in contact with the surface, the metal salt of the initiator component of the composition is reduced at the surface, thereby initiating cure of the cationically curable component of the composition.

2. A curable composition according to claim 1, wherein the metal salt comprises a transition metal cation.

3. A curable composition according to claim 2, wherein the transition metal cation is selected from silver, copper and combinations thereof.

4. A curable composition according to claim 2, wherein the metal salt includes a counterion chosen from the group consisting of ClO₄⁻, BF₄⁻, PF₆⁻, SbF₆⁻, AsF₆⁻, (C₆F₅)₄B, (C₆F₅)₄Ga, carborane, triflimide, bis-triflimide, and combinations thereof.

5. A curable composition according to claim 1, wherein the cationically curable component has at least one functional group selected from the group consisting of epoxy, vinyl, oxetane, thioxetane, episulfide, tetrahydrofuran, oxazoline, oxazine, lactone, trioxane, dioxane, styrene and combinations thereof.

6. A curable composition according to claim 1, wherein the surface comprises a metal, metal oxide or metal alloy.

7. A curable composition according to claim 1, wherein the surface is selected from the group consisting of iron, steel, mild steel, gritblasted mild steel, aluminium, aluminium oxide, copper, zinc, zinc oxide, zinc bichromate, and stainless steel.

8. A curable composition according to claim 1, further comprising a metal oxide removal agent.

9. A curable composition according to claim 8, wherein the metal oxide removal agent is selected from the group consisting of chloride ions, zinc (II) salts and combinations thereof.

10. A curable composition according to claim 1 further comprising a catalyst to effect electron transfer between the surface and the metal salt.

11. A curable composition according to claim 1 for adhering a first metallic substrate to another substrate.

12. A curable composition according to claim 1 for sealing.

13. Use of the composition of claim 1 in thread locking, flange sealing, structural bonding and/or metal bonding.

14. Use of at least one metal salt for initiating cure of a cationically curable composition on a surface, wherein the standard reduction potential of the metal salt is greater than the standard reduction potential of the surface.

15. A process for bonding two substrates together comprising comprising the steps of:
(i) applying a composition comprising:
i) a cationically curable component; and
ii) an initiator component comprising at least one metal salt;
to at least one substrate, and
(ii) mating the first and second substrates so as to form a bond with the composition,
where the standard reduction potential of the initiator component is greater than the standard reduction potential of at least one of the substrates.

16. A process according to claim 15 wherein at least one substrate comprises a metal, metal oxide or metal alloy.

17. A process according to claim 16 wherein at least one substrate comprises a metal.

18. A pack comprising:
i) a container; and
ii) a cationically curable composition according to claim 1.

19. A pack according to claim 18, wherein the container is air permeable.

20. A pack according to claim 19, wherein the container is not air permeable.
